(19) United States
(12) Patent Application Publication
(10) Pub. No.: US 2009/0142074 A1
(43) Pub. Date: Jun. 4, 2009

(54) OPTICAL RECEIVING APPARATUS, OPTICAL LINE TERMINAL APPARATUS, AND OPTICAL NETWORK SYSTEM

(75) Inventor: Satoshi Ide, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/191,437

(22) Filed: Aug. 14, 2008

(30) Foreign Application Priority Data
Dec. 3, 2007 (JP) 2007-311915

(51) Int. Cl. H04B 10/06

(52) U.S. Cl. 398/202

(57) ABSTRACT

The optical receiving apparatus of the present invention is provided with an optical receiving unit which receives a burst optical signal and outputs a signal in accordance with an optical reception level, a preamplification unit which amplifies the signal from the optical receiving unit, a direct-current component removing unit which removes a direct-current component of a signal output from the preamplification unit and has a variable response time constant, and a time-constant control unit which controls the response time constant of the direct-current component removing unit based on a signal indicating the rising edge of the burst optical signal and a signal indicating the falling edge of the burst optical signal. According to this constitution, the shortening of the rise time and the securing of the tolerance against the same code succession can be simultaneously realized.

### BACKGROUND OF THE INVENTION

1) Field of the Invention

The present invention relates to an optical receiving apparatus, an optical line terminal apparatus, and an optical network system suitable for an optical communication system.

2) Description of the Related Art

To cope with the explosive increase of data traffic as typified by the Internet, the establishment of high-speed broadband optical access network with a large capacitance has been rapidly developed. In the high-speed optical access system, high-speed transmission having a maximum downlink data rate of 2.4 Gbps is realized, and in addition, there is a widespread use of G-PON (Gigabit-Passive Optical Network) sharing an optical fiber network between a subscriber and a station; however, in order to realize higher speed transmission, the development of 10 G-PON system which can realize the large capacitance transmission at 10 Gbps for example is accelerated.

In the 10 G-PON system, an uplink transmission from a subscriber apparatus (ONU: Optical Network Unit) to a station-side apparatus (OLT: Optical Line Terminal) adopts a TDMA (Time Domain Multiple Access) system in which a packet from each subscriber apparatus is connected in a time-division multiplexing manner. Here, a dynamic range due to the difference in loss of a transmission line in each ONU exceeds 20 dB (100 times), whereby burst optical signals are transmitted at a very short interval, that is, with a guard time between packets of several 10 ns. In the OLT, the realization of a burst optical receiver which instantly determines an optical packet having a level substantially different in each ONU is required.

In the burst transmission, it is essential to develop a optical receiving apparatus which detects packet input with high accuracy in a preamble part of the header of a packet for improving transmission efficiency, and, at the same time, can simultaneously realize the early transition to the state in which an on/off code (in general, a bit code) of optical signal based on the level detection can be identified (the shortening of the setup time of optical receiver) and the tolerance against the long succession of the same codes (same code succession tolerance) in data (payload) in the identification of the optical on/off code. Especially, when a bit rate is increased, it becomes difficult to develop the optical receiving apparatus which can simultaneously realize the above functions.

In Japanese Patent Application Laid-Open No. 6-310967, in the prior art PON, the peak level and the bottom level of a signal are detected by a peak (bottom) detection circuit, and thus, a threshold level is set at the center of the signal, whereby the level detection in a preamble can be realized, and, at the same time, the retention of level in the same code succession in payload in the identification of the bit code can be realized.

Meanwhile, in Japanese Patent Application Laid-Open No. 6-232916, the peak detection of the output level is fed back, whereby the unipolar/bipolar signal conversion can be realized.

However, it is difficult to design the peak detection circuits disclosed in the above publications because they are high-speed feed back circuits, and, especially, when a system transmitting a signal of at least about 10 Gbps is assumed, it is difficult to realize such a peak detection circuit in view of the response speed of the circuit.

### SUMMARY OF THE INVENTION

An object of the present invention is to simultaneously realize the optical receiving apparatus for the optical burst transmission, which shorten the setup time and the secure the tolerance against the same code succession without using a peak detection circuit.

Another object of the present invention is to provide an effect obtained by each constitution shown in a best mode for carrying out the invention to be described below, that is, an effect which cannot be obtained by the prior art.

(1) A optical receiving apparatus of the present invention has a optical receiving unit which receives a burst optical signal and outputs a signal in accordance with a optical signal level; a preamplification unit which amplifies a signal from the optical receiving unit; a direct-current component removing unit which removes a direct-current component of a signal output from the preamplification unit and has a variable response time constant; and a time-constant control unit which controls the response time constant of the direct-current component removing unit based on a signal indicating a rising edge of the burst optical signal and a signal indicating a falling edge of the burst optical signal.

(2) Further, an optical line terminal apparatus of the present invention has the optical receiving apparatus described in (1).

(3) Further, an optical network system of the present invention has the optical line terminal apparatus to which the optical receiving apparatus described in (1) is applied.

There is an advantage that because the optical receiving apparatus has the direct-current component removing unit and the time-constant control unit, the shortening of the setup time and the securing of the tolerance against the same code succession can be simultaneously realized without using a peak detection circuit.

### BRIEF DESCRIPTION OF THE DRAWINGS

FIG. 1 is a view showing an optical receiving apparatus according to a first embodiment;

FIGS. 2 and 3 are views showing a DCFB in the first embodiment;

FIG. 4 is a view showing an optical network system to which the optical receiving apparatus of this embodiment is applied;

FIG. 5 is a view for explaining a problem to be solved by the optical receiving apparatus of this embodiment;

FIG. 6 is a view for explaining an operation of the optical receiving apparatus according to the first embodiment;

FIGS. 7, 9 and 10 are views showing a modification of the first embodiment;

FIG. 8 is a view for explaining the operation of the modification of the first embodiment;

FIG. 11 is a view showing an optical receiving apparatus according to a second embodiment;

FIG. 12 is a view for explaining an operation of the optical receiving apparatus according to a second embodiment;

FIG. 13 is a view showing an optical receiving apparatus according to a third embodiment;

FIGS. 14 to 17 are views showing a direct-current component removing circuit in the third embodiment;

FIGS. 18 and 19 are views showing a modification of the third embodiment; and

FIG. 20 is a view showing an optical receiving apparatus according to the forth embodiment.

### DESCRIPTION OF THE PREFERRED EMBODIMENTS

Hereinafter, the embodiments of the present invention are described with reference to the drawings.

The present invention is not limited to the following embodiments. In addition to the above objects of the present invention, other technical problems, means for solving the technical problems, and operational effects thereof will be apparent in the disclosure of the following embodiments.

### [A] Description of a First Embodiment

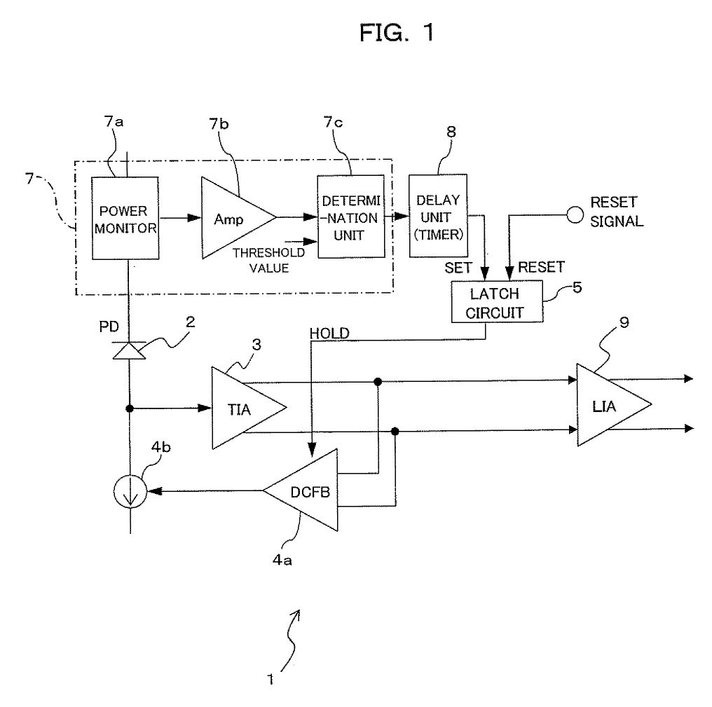

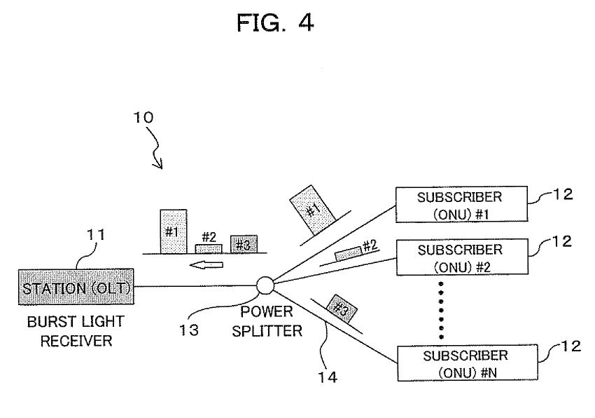

FIG. 1 is a view showing an optical receiving apparatus 1 according to the first embodiment of the present invention. The optical receiving apparatus 1 shown in FIG. 1 can be applied as an optical receiving apparatus which receives an uplink burst optical signal from each ONU 12 in an optical line terminal apparatus 11 in a network system 10 such as a 10 gigabit passive optical network (10 G-PON) as shown in FIG. 4. In the network system 10 shown in FIG. 4, the OLT 11 and each ONU 12 are connected through a power splitter 13 and an optical transmission line 14.

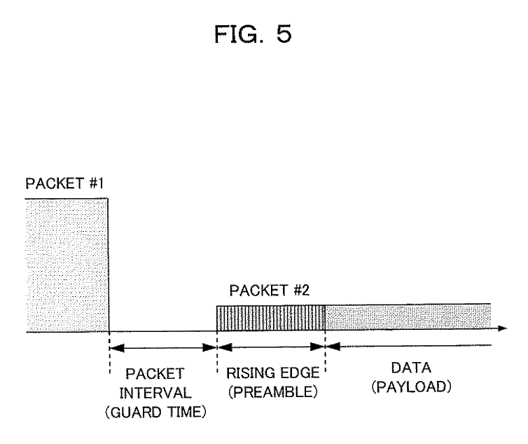

Here, the received optical level of a burst optical packet (see, #1 to #3 in FIG. 4) from the ONU 12 received in the OLT 11 in the above network system such as 10 G-PON significantly changes depending on the difference in loss of the transmission line through which each ONU 12 and the relevant OLT 11 are connected to each other. Especially, in the high-speed network system 10 such as 10 G-PON, as shown in, for example, FIG. 5, the burst optical packets (packets #1 and #2) having a different received optical level are required to be received with a relatively short guard time of about several ns.

In the optical receiving apparatus 1 according to the first embodiment, even when the optical packet, which constitutes the above burst optical signal having a different received optical level, is received with a guard time of about several ns, the response time is shortened without applying a peak detection circuit with a feed back circuit structure, whereby the optical packet input with a relatively short guard time can be captured as a data signal.

Here, the optical receiving apparatus 1 shown in FIG. 1 has a photo diode (PD) 2, a transimpedance amplifier (TIA) 3, a direct-current feedback (DCFB) amplifier 4a, a current source 4b, and a latch circuit 5, further has a power monitor 7a, an amplifier 7b, a determination unit 7c, and a delay unit 8, and still further has a limiter amplifier (LIA) 9.

Here, the PD 2 is an optical receiving unit which receives the burst optical signal and outputs a signal (current signal) in accordance with an optical reception level. The TIA 3 amplifies an electrical signal (an electrical signal from an anode side of the PD 2) in accordance with the optical signal level in the PD 2, in other words, is a preamplification unit (preamplifier) which amplifies the electrical signal from the PD 2. The LIA 9 amplifies a signal from the TIA 3 constituting the preamplification unit to change the signal into a binarized signal corresponding to a modulation digital signal (binarized signal) on a transmitter side (ONU 12).

The power monitor 7a monitors a power of the optical signal in the PD 2 based on the electrical signal on the cathode side of the PD 2. Namely, in the power monitor 7a, the electrical signal having a magnitude corresponding to the power of the optical signal in the PD 2 is output. The amplifier 7b amplifies the electrical signal from the power monitor 7a to regulate the level of the electrical signal, and thereafter to send the electrical signal to the post stage of the determination unit 7c. As the amplifier 7b, an amplifier, which can cover a relatively large range as an amplifiable level, such as a log amp is applied so that it can correspond to the difference in the level of the burst optical signal to be input.

In the determination unit 7c, the header of the burst optical signal constituted of the optical packet, that is, the rising edge of the burst optical signal is detected based on the optical monitoring result input through the amplifier 7b, that is, the monitoring result of the optical received in the PD2. Specifically, the magnitude between the electrical signal as the monitoring result input through the amplifier 7b and a predetermined threshold level are compared to each other, the rising edge of the input of the optical packet constituting the burst optical signal is detected, and, when the burst optical signal rises, the response informing the rising edge of the burst optical signal is output within a preamble time of the optical packet constituting the burst optical signal. Accordingly, the power monitor 7a, the amplifier 7b, and the determination unit 7c constitute a rising edge detection unit 7 which detects the rising edge of the burst optical signal.

The power monitor 7a, the amplifier 7b, and the determination unit 7c may have a response speed at which the starting of the input of the optical packet, constituting the burst optical signal, can be determined within the preamble time of the relevant packet at the post stage. Namely, especially the power monitor 7a may have a response speed in the detection of the modification of the power at which the rising edge of the burst optical signal can be detected within the preamble time (see, FIG. 5) of the relevant packet, and therefore, the power monitor 7a may not have a speed at which on/off of a optical signal with a frequency of a data rate modulated into the optical packet is detected. For example, the OLT 11 in the 10 G-PON network system 10 in the first embodiment may have a speed at which the on/off of an optical signal of about 100 MHz can be detected.

Further, the delay unit 8 is constituted of a timer circuit for example, and delays a signal indicating a determination result in the determination unit 7c to output the signal to the latch circuit 5. The delay unit 8 is a first delay unit which gives a delay to a signal indicating a detection result in the rising edge detection unit 7 to output the signal as a set signal to the latch circuit 5.

The latch circuit 5 is a time-constant control unit which controls the response time constant of the DCFB 4a based on the signals respectively indicating the rising edge and the falling edge of the burst optical signal received in the PD 2. Specifically, a signal input from the determination unit 7c through the delay unit 8, that is, a signal, which indicates the rising edge of the burst optical signal and serves as a set input, and a signal, which indicates the falling edge of the burst optical signal from the out side and serves as a reset signal, are respectively input to the latch circuit 5, and thus, the latch circuit 5 is constituted as a hold signal output circuit which generates and outputs a hold signal. In other words, in the latch circuit 5 as the hold signal output circuit, while the hold signal is output by the input of the set signal indicating the rising edge of the burst optical signal, the hold signal is released by the input of the reset signal indicating the falling edge of the burst optical signal from the outside.

Further, when the rising edge detection unit 7 and the delay unit 8 constitute a set signal output unit which, when having detected the rising edge of the burst optical signal, outputs the set signal serving as the set input to the latch circuit 5 which is the hold signal output circuit.

The optical line terminal apparatus 11 to which the optical receiving apparatus 1 in the first embodiment is applied has a function of controlling a timing at which the optical packet from each ONU 12 is received as the burst optical signal. Thus, when the optical line terminal apparatus 11 receives a signal indicating the falling edge of the burst optical signal from the function of controlling the optical signal timing, the received signal indicating the falling edge of the burst optical signal can be applied as a reset input.

Here, when the latch circuit 5 as the hold signal output circuit outputs the hold signal, that is, when the burst optical signal rises, the response time constant of the DCFB 4a to be described below is increased relatively. Meanwhile, when the hold signal is reset, that is, when the burst optical signal falls, the response time constant of the DCFB 4a is controlled so as to be decreased relatively.

The direct-current feedback amplifier (DCFB) 4a outputs a level, which corresponds to the average value of two optical receiving signal components differentially output from the TIA 3, as a direct-current component. The direct-current signal output from the DCFB 4a which is a component subtracted from the optical receiving signal (electrical signal) output from the PD 2 is supplied to the current source 4b. Namely, regarding the optical receiving signal from the PD 2, the direct-current signal from the DCFB 4a is removed in the current source 4b to be output to the TIA 3. According to this constitution, in the TIA 3 in the first embodiment, a signal in which the direct-current component in the optical receiving signal from the PD 2 is removed by feedback is amplified and differentially output.

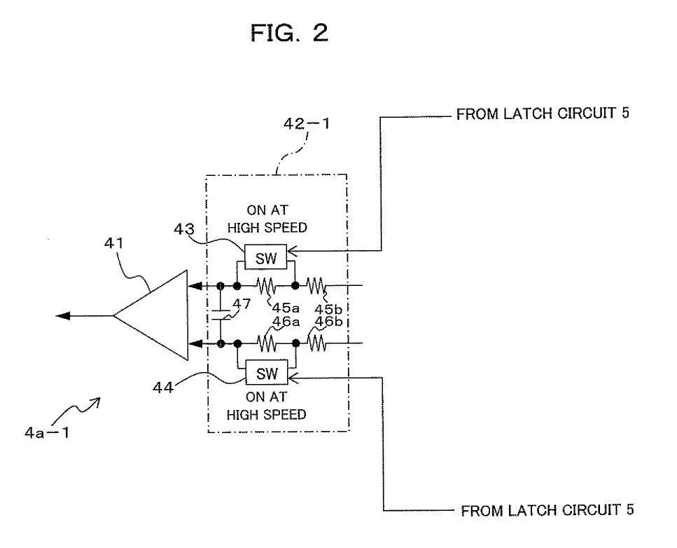

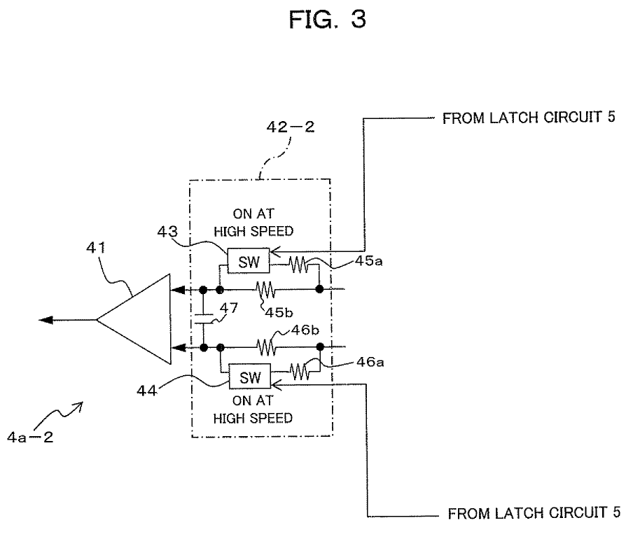

The DCFB amplifier 4a is constituted so that the time constant can be variably set in accordance with a signal from the latch circuit 5, and can be constituted as shown in FIGS. 2 and 3 for example. DCFB amplifiers 4a-1 and 4a-2 respectively shown in FIGS. 2 and 3 have an RC circuits 42-1 and 42-2 respectively using two output signals from the TIA 3 as the inputs thereto, and further has an amplifier 41 outputting a signal corresponding to the average value of two optical receiving signal components from the RC circuits 42-1 and 42-2.

The RC circuit 42-1 shown in FIG. 2 has resistances 45a, 45b and resistances 46a, 46b connected in series to two outputs from the TIA 3, and further has a capacitance 47 and switch circuits 43 and 44. The switch circuits 43 and 44 are respectively connected to the both ends of the resistances 45a and 46a, and turned on by the reset of the hold signal from the latch circuit 5, while they are turned off by the set of the hold signal. Namely, the respective both ends of the resistances 45a and 46a are switched on/off by the switch circuits 43 and 44, whereby the response time constant in the RC circuit 42-1 can be switched.

The RC circuit 42-2 shown in FIG. 3 has resistances 45a, 45b and resistances 46a, 46b connected in series to two outputs from the TIA 3, and further has a capacitance 47 and switch circuits 43 and 44. The switch circuits 43 and 44 are respectively connected to the both ends of the resistances 45a and 46a, and turned on by the reset of the hold signal from the latch circuit 5, while they are turned off by the set of the hold signal. Namely, the respective both ends of the resistances 45a and 46a are switched on/off by the switch circuits 43 and 44, whereby the response time constant in the RC circuit 42-2 can be switched.

The DCFB amplifier 4a-1 and 4a-2 having the above constitution have the RC circuits 42-1 and 42-2 in which the response time constant is switched in accordance with the signal from the latch circuit 5, and therefore the output response time constant of a value corresponding to the average value of two optical receiving signal components differentially output from the TIA 3 is switched in accordance with the signal from the latch circuit 5 to be fed back to the TIA 3 input.

According to the above constitution, the switches 43 and 44 are turned on to reduce the response time constant, and, thus, to accelerate the response in the DCFB amplifier 4a to relatively high speed, whereby the next burst optical signal can be detected at the rising edge of the burst optical signal. Meanwhile, the switches 43 and 44 are turned off to increase the response time constant, and, thus, to decelerate the response in the DCFB 4a to relatively low speed, whereby the resistance against the same code succession can be increased.

Accordingly, the DCFB 4a and the current source 4b shown in FIG. 1 constitute a direct-current component removing circuit which removes the direct-current component of the signal output from the TIA 3 and has a variable response time constant. The direct-current component removing circuit serves as a negative feedback circuit which negatively feeds back the direct-current component of the signal output from the TIA 3 to a signal output from the PD 2 to the TIA 3.

Namely, in the signal output from the TIA 3, the electrical signal having a waveform corresponding to a code pattern of an optical packet received through the PD 2 can be made a bipolar signal, from which the direct-current component is removed, by the direct-current component removing circuit. When the bipolar signal is received in the LIA 9, the bipolar signal can be made a digital electrical signal corresponding to an optical on/off code in the received optical packet, regardless of the optical intensity of the received optical packet, the guard time, and so on.

At that time, in the stage before the rising edge of the burst optical signal is detected from the monitoring result of the optical received in the PD 2, the response time constant of the DCFB 4a is set to a small value, whereby a signal component, which is used for removing a direct-current component at the output, from the TIA 3, of the electrical signal corresponding to the following data region, can be established within a time for a signal corresponding to a payload region to pass through the TIA 3.

At that time, the DCFB 4a as the direct-current component removing circuit generates a signal, which has a level corresponding to the average level of the electrical signal input from the TIA 3, as a direct-current component to be removed. Thus, when the code patterns in the data (payload) region of the optical packet, especially the same codes, are continued (a quenching time corresponding to a code “0” for example), it can be assumed that the direct-current component to be removed undergoes a change in the same packet. In this case, the removal accuracy of the direct-current component in the electrical signal, which is output from the TIA 3 and corresponds to the on/off code of the optical packet, is deteriorated, and thus the quality of the signal received in the LIA 9 is deteriorated.

Therefore, when the rising edge of the burst optical signal is detected in the rising edge detection unit 7, the response time constant of the DCFB 4a is changed from a small value to a large value at the time when a optical signal, which corresponds to the data region following the payload region of the relevant optical packet, is input to the TIA 3. According to this constitution, a value which does not substantially vary from the value of the direct-current component established in the payload region can be used as a removal component when outputting the bipolar electrical signal, corresponding to the following data region, from the TIA 3, whereby, even when the same codes are continued in the data region, the direct-current component can be stably removed.

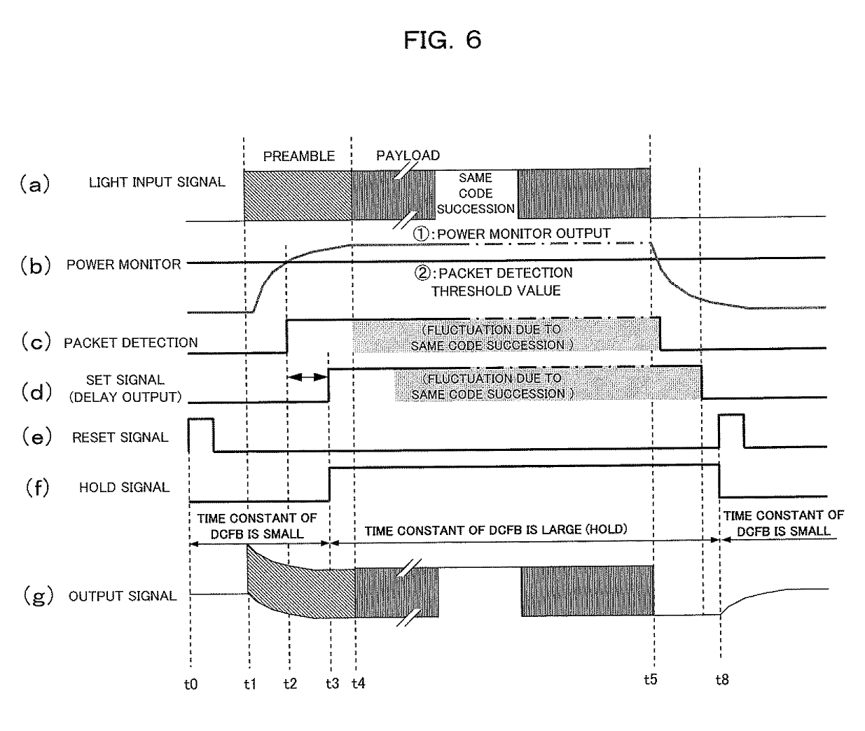

FIG. 6 is a view for explaining an operation of the optical receiving apparatus 1 according to the first embodiment having the above constitution. It is assumed that the optical packet constituted of the payload region (t4 to t5) following the preamble region (t1 to t4) is received, as shown in (a) of FIG. 6. When a reset signal from the outside is input to the latch circuit 5 in the stage at which the reception of the preceding optical packet is completed (t0 in (e)), the latch circuit 5 outputs a control signal to the DCFB 4a so that the response time constant of the DCFB 4a becomes a small value. Thereby, in preparation for the input of the following optical packet, the DCFB 4a is in a state that the signal for removing the direct-current component can be generated at relatively high speed response (t0 to t3 in (g)).

Subsequently, in the determination unit 7c, when a power monitor signal input from the power monitor 7a through the amplifier 7b exceeds a predetermined threshold level (a value sufficient to determine the input of the optical packet), the signal indicating the exceeding of the threshold level is output (t2 in (b) and (c)). The signal from the determination unit 7c, which is the detection signal of the rising edge of the burst optical signal which constitutes the optical packet following the preceding optical packet, is given to the delay unit 8.

The delay unit 8 gives a delay to the detection signal of the rising edge of the burst optical signal from the determination unit 7c (t2 to t3) to supply the detection signal as a set signal to the latch circuit 5 (t3 in (d)). The latch circuit 5 receives the set signal from the delay unit 8 to raise the hold signal to the DCFB 4a (t3 in (f)). According to this constitution, the latch circuit 5 can control the DCFB 4a so that the response time constant of the DCFB 4a is relatively large at the time when the electrical signal corresponding to the payload region is output from the TIA 3.

As above described, the response time constant of the DCFB 4a is controlled to be switched by the latch circuit 5, and therefore, at the time when the electrical signal corresponding to the preamble region of the optical packet is output, the signal output from the TIA 3 can be stabilized to a bipolar signal, from which the direct-current component is removed at relatively high speed, that is, within a time corresponding to the relevant preamble (t1 to t4 in (g)); meanwhile, the signal output from the TIA 3 can be output as a bipolar signal, from which the direct-current component is stably removed even if the region where the same codes are continued is included in the payload region (data region) (t4 to t5 in (g)).

The succession of the same codes in the data region causes the fluctuation of the rising edge detection signal in the rising edge detection unit 7 and the set signal to the latch circuit 5. However, in the first embodiment, the reset signal input to the latch circuit 5 (t0 and t8 in (e)) is input from the outside of the optical receiving apparatus 1 in accordance with a timing of the guard time grasped in the OLT 11. This reset signal is a trigger to reduce the response time constant of the DCFB 4a, whereby the stability of the operation of the DCFB 4a in the data region is ensured.

As above, according to the first embodiment of the present invention, there is an advantage that the shortening of the rising time and the securing of the resistance against the same code succession can be simultaneously realized without using a peak detection circuit.

### [A1] Description of a Modification of the First Embodiment

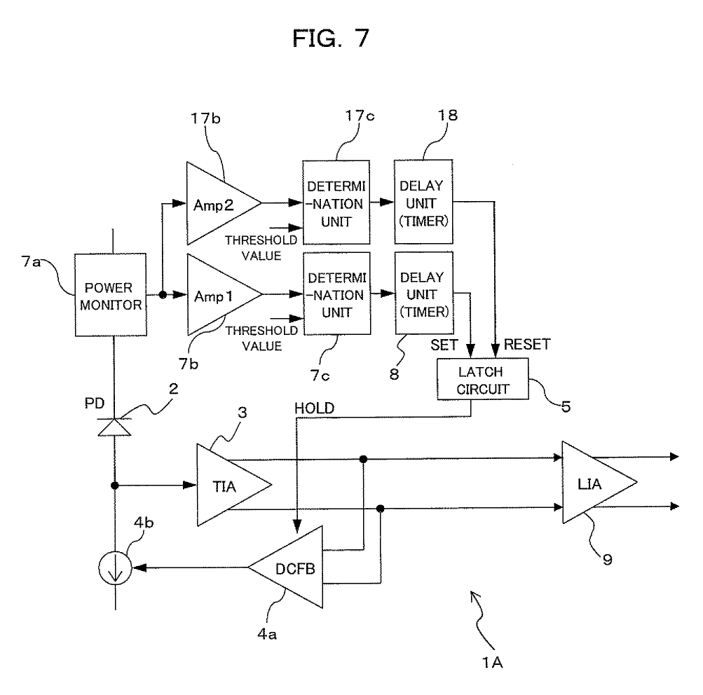

FIG. 7 is a view showing a optical receiving apparatus 1A according to a first modification of the first embodiment. The optical receiving apparatus 1A shown in FIG. 7 is different from the optical receiving apparatus 1 in the first embodiment in further having a constitution for generating a reset signal to the latch circuit 5 from the monitoring result of the optical receiving signal from the PD 2. In FIG. 7, the same reference numerals as FIG. 1 denote similar units as in FIG. 1.

The amplifier 17b amplifies the electrical signal from the power monitor 7a to regulate the level of the electrical signal, and thereafter to send the amplified electrical signal to the determination unit 17c. In the determination unit 17c, the magnitude between the amplified electrical signal from the amplifier 17b and a predetermined threshold level is compared to each other, thereby detecting the falling edge of the burst optical signal. That is, the determination unit 17c determines whether or not the input of the optical packet received by time division multi-accessing is terminated. And, when the determination unit 17c detects the falling edge of the burst optical signal, the response informing the falling edge of the burst optical is output within the guard time between the relevant optical packets. Thus, the power monitor 7a, the amplifier 17b, and the determination unit 17c constitute a falling edge detection unit for detecting the falling edge of the burst optical signal.

In order to realize the threshold level determination in the determination unit 17c, in which the falling edge of the burst optical signal can be reliably detected in distinction from the same code succession in the data region, the gain of the amplifier 17b may be set to have a value different from the gain of the amplifier 7b, or the threshold level in the determination unit 17c may be set to have a value different from the threshold level in the determination unit 7c.

The delay unit 18 is a second delay unit which gives a delay to a signal indicating the detection result in the determination unit 17c as a falling edge detection unit to output the signal as a reset signal to the latch circuit 5. In other words, the power monitor 7a, the amplifier 17b, the determination unit 17c, and the delay unit 18 constitute a rest signal output unit which, when detecting the falling edge of the burst optical signal, outputs a rest signal serving as a reset input to the latch circuit 5.

According to the above constitution, in the latch circuit 5, the output of the hold signal to the DCFB 4a is switched based on the set signal as the set input from the delay unit 8 as a set signal output unit and the reset signal as the reset input from the delay unit 18 as a reset signal output unit. Namely, the latch circuit 5 outputs the hold signal based on the set input, while releasing the hold signal based on the reset input. The response time constant of the DCFB 4a can be switched through the output and the release of the hold signal in the latch circuit 5.

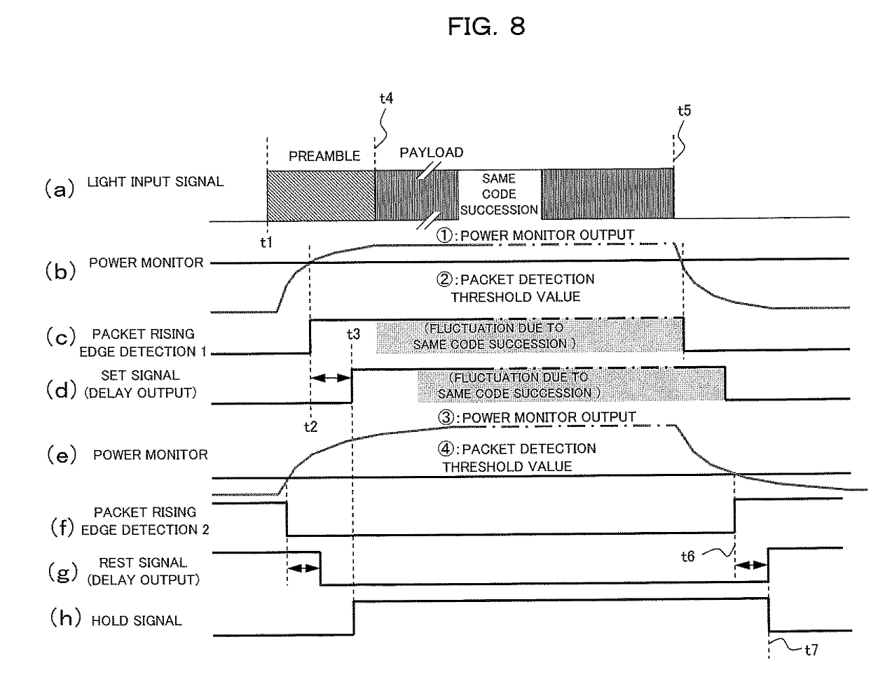

FIG. 8 is a view for explaining an operation of the optical receiving apparatus 1A having the above constitution. Also in this case, it is assumed that the optical packet constituted of the payload region (t4 to t5) following the preamble region (t1 to t4) is received, as shown in (a) of FIG. 8. As with the case shown in FIG. 6, when the rising edge of the burst optical signal is detected in the determination unit 7c, a signal indicating the rising edge of the burst optical signal as the set signal to the latch circuit 5 is supplied through the delay unit 8 (t2 and t3 of (b) to (d)). According to this constitution, the latch circuit 5 raises the hold signal (t3 of (h)), and can control the DCFB 4a so that the response time constant of the DCFB 4a is increased relatively at the time when the electrical signal corresponding to the payload region is output from the TIA 3.

Meanwhile, in the determination unit 17c, if the power monitor signal input from the power monitor 7a through the amplifier 17b is less than a predetermined threshold level (a value sufficient to determine the input of the optical packet), the signal indicating that the power monitor signal is less than the threshold level is output (t6 in (e) and (f)). The signal from the determination unit 17c as the detection signal of the falling edge of the burst optical signal is given to the delay unit 18.

The delay unit 18 gives a delay to the detection signal of the falling edge of the burst optical signal from the determination unit 17c (t6 to t7) to supply the detection signal as a reset signal to the latch circuit 5 (t7 in (g)). The latch circuit 5 receives the reset signal from the delay unit 18 to raise the hold signal to the DCFB 4a (t7 in (h)). According to this constitution, the latch circuit 5 can control the DCFB 4a so that the response time constant of the DCFB 4a is relatively small within the guard time before the input of the following optical packet.

As above, also in the optical receiving apparatus shown in FIG. 7, an advantage similar to the case of the first embodiment can be obtained.

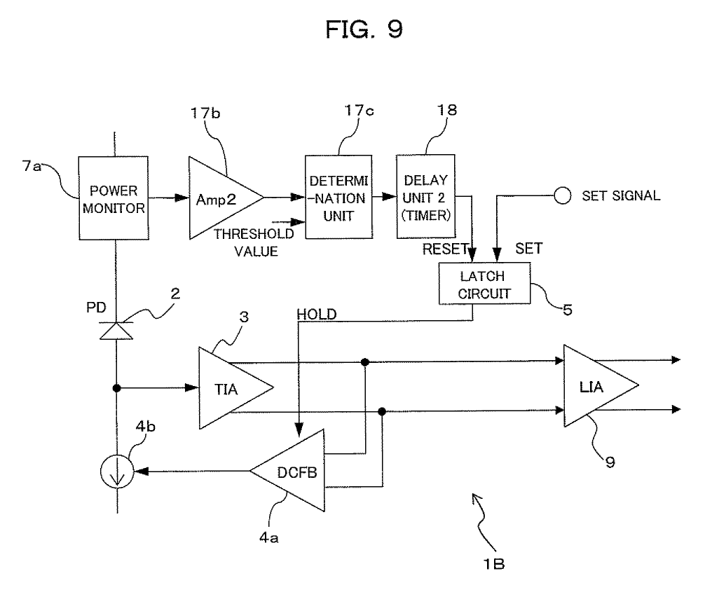

In the constitution shown in FIG. 7, the components for generating the reset signal to the latch circuit 5 are added to the constitution of FIG. 1; however, according to the present invention, as in a optical receiving apparatus 1B shown in FIG. 9 for example, while a signal which indicates the rising edge of the burst optical signal and is received from the outside serves as a set input to the latch circuit 5, the components which are similar to those shown in FIG. 7 (7a, 17b, 17c, and 18) and generate the reset signal to the latch circuit 5 may be provided.

Here, the optical line terminal apparatus 11 (see, FIG. 4) to which the optical receiving apparatus 1B is applied has a function of controlling a timing at which the optical packet from each OLT 12 is received as the burst optical signal. In this case, the signal indicating the rising edge of the burst optical signal as the set signal to the latch circuit 5 can be received from the function of controlling the reception timing.

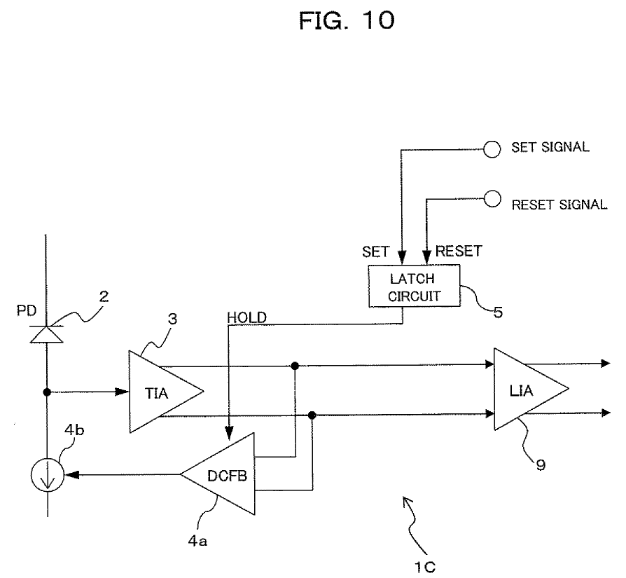

Meanwhile, as an optical receiving apparatus 1C shown in FIG. 10, while the signal indicating the rising edge of the burst optical signal received from the above reception timing control function serves as the set input (Set signal) to the latch circuit 5, a signal indicating the falling edge of the burst optical signal received from the above reception timing control function can serve as the reset input (Reset signal) to the latch circuit 5. According to this constitution, the power monitor 7a, the amplifiers 7b and 17b, the determination units 7c and 17c, and the delay units 8, 18 can be omitted from the circuit configuration.

### [B] Description of a Second Embodiment

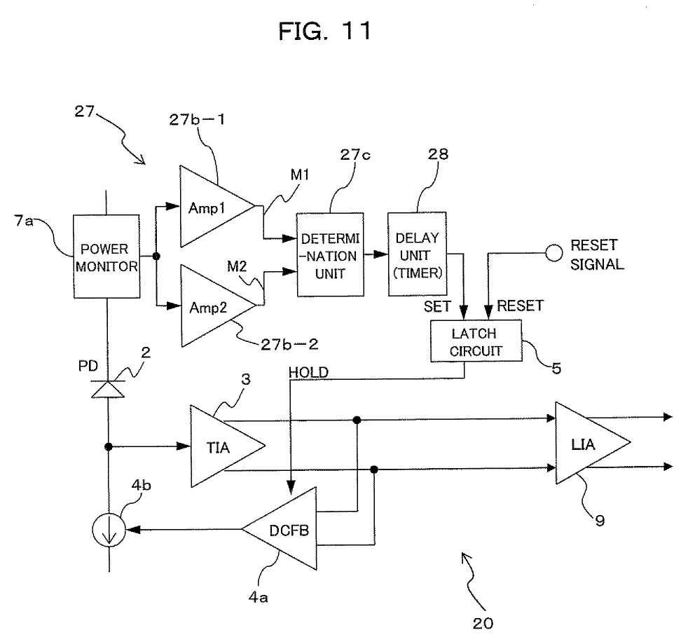

FIG. 11 is a view showing a optical receiving apparatus 20 according to the second embodiment of the present invention. As with the case in the first embodiment, the optical receiving apparatus 20 shown in FIG. 11 is applied to the optical line terminal apparatus 11 in the 10 G-PON network system 10 shown in FIG. 4 for example, and the latch circuit 5 switches the response time constant of the DCFB 4a, whereby the shortening of the setup time and the securing of the tolerance against the same code succession without applying peak detection can be simultaneously realized. However, the constitution of a rising edge detection unit 27 for generating the set signal to the latch circuit 5 is different from the constitution in the first embodiment. In FIG. 11, the same reference numerals as FIG. 1 denote similar units as in FIG. 1.

Here, the rising edge detection unit 27 has a power monitor 7a similar to that of the optical receiving apparatus 1 shown in FIG. 1, two amplifiers 27b-1 and 27b-2 having response time constants different from each other, a determination unit 27c, and a delay unit 28. The amplifiers 27b-1 and 27b-2 amplify a monitor electrical signal from the power monitor 7a, and, for instance, have a constitution in which the response time constant and the gain of the amplifier 27b-1 are relatively small, while the response time constant and the gain of the amplifier 27b-2 are relatively large.

Thus, the power monitor 7a and the amplifier 27b-1 constitute a first monitor which monitors a power of a signal received in the PD 2 and has a relatively small time constant and gain, and the power monitor 7a and the amplifier 27b-2 constitute a second monitor which monitors a power of a signal received in the PD 2 and has a relatively large time constant and gain.

The determination unit (rising edge determination unit) 27c detects the rising edge of the burst optical signal based on the monitoring result in the first and second monitors, that is, the monitor electrical signal from the amplifiers 27b-1 and 27b-2, to output the detection result as the set input to the latch circuit 5. Specifically, the determination unit 27c determines the timing, when a monitor electrical signal Ml from the amplifier 27b-1 and a monitor electrical signal M2 from the amplifier 27b-2 are overlapped, as the rising edge of the burst optical signal, and outputs the determination result as the set input to the latch circuit 5.

According to the above constitution, the latch circuit 5 outputs a hold signal based on the detection signal as the set input from the determination unit 27c, and, as with the case in the first embodiment, can switch the response time constant of the DCFB 4a through the release of the hold signal with the aid of the application of the reset input from the outside as with the case in the first embodiment.

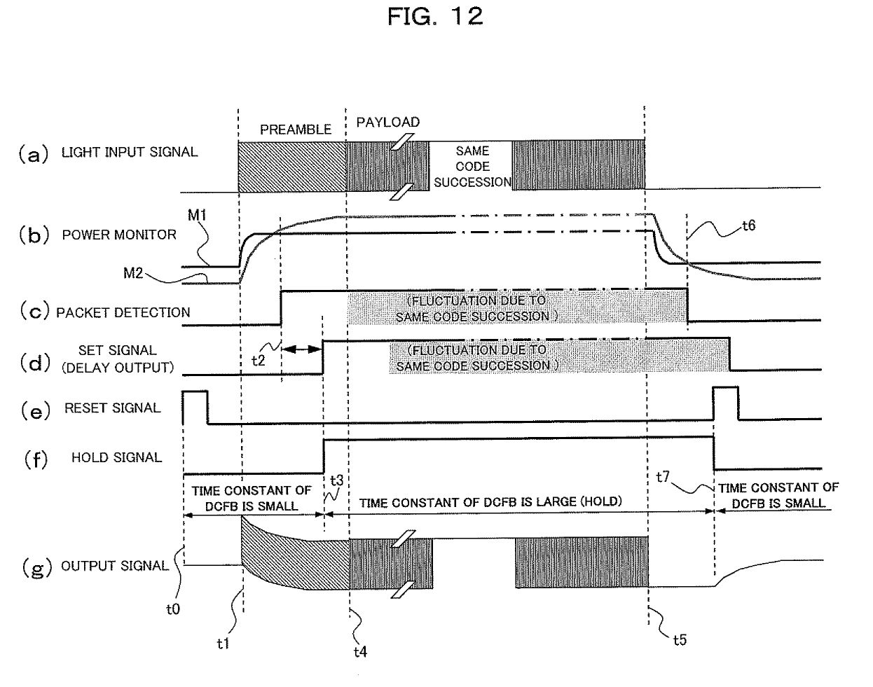

FIG. 12 is a view for explaining an operation of the optical receiving apparatus 20 having the above constitution. It is assumed that the optical packet constituted of the payload region (t4 to t5) following the preamble region (t1 to t4) is received, as shown in FIG. 12. When the reset signal from the outside is input to the latch circuit 5 in the stage at which the reception of the preceding optical packet is completed (t0 in (e)), the latch circuit 5 outputs a control signal to the DCFB 4a so that the response time constant of the DCFB 4a becomes a small value. Accordingly, in preparation for the input of the following optical packet, the DCFB 4a is in a state that the signal for removing the direct-current component can be generated at relatively high speed response (t0 to t3 in (g)).

Subsequently, the monitor electrical signal M1 input from the power monitor 7a through the amplifier 27b-1 and the monitor electrical signal M2 input from the power monitor 7a through the amplifier 27b-2 are input to the determination unit 27c, and the determination unit 27c determines the timing at which these monitor electrical signals M1 and M2 are overlapped as the rising edge of the burst optical signal (t2 in (b)).

Namely, the rising edge of the monitor electrical signal M1 is more precipitous than the rising edge of the monitor electrical signal M2, and is stabilized on a relatively smaller level than the monitor electrical signal M2. Thus, it can be assumed that, when the input of the optical packet is started, the monitor electrical signals M1 and M2 can cross at a point. The determination unit 27c outputs a signal, which indicates the timing of this crossing point, as a detection signal of the rising edge of the burst optical signal.

The determination unit 7c in the first embodiment determines the rising edge of the packet through the determination of the magnitude between the electrical signal and a predetermined fixed threshold level, and therefore, the difference in the detection time occurs due to the optical intensity of the input optical packet. In the second embodiment, the packet detection can be performed through the relative comparison of the amplitude of the monitor electrical signals M1 and M2, whereby a stable detection can be realized without the time required for the packet detection depending on the optical intensity of the packet itself.

The delay unit 28 gives a delay to the detection signal of the rising edge of the burst optical signal from the determination unit 27c (t2 to t3) to supply the detection signal as a set signal to the latch circuit 5 (t3 in (d)). The latch circuit 5 receives the set signal from the delay unit 8 to raise the hold signal to the DCFB 4a (t3 in (f)). According to this constitution, the latch circuit 5 can control the DCFB 4a so that the response time constant of the DCFB 4a is relatively large at the time when the electrical signal corresponding to the payload region is output from the TIA 3.

As described above, the response time constant of the DCFB 4a is controlled to be switched by the latch circuit 5, and therefore, at the time when the electrical signal corresponding to the preamble region of the optical packet is output, the signal output from the TIA 3 can be stabilized to a bipolar signal, from which the direct-current component is removed at relatively high speed, that is, within a time corresponding to the relevant preamble (t1 to t4 in (g)); meanwhile, the signal output from the TIA 3 can be output as a bipolar signal, from which the direct-current component is stably removed even if the region where the same codes are continued is included in the payload region (data region) (t4 to t5 of (g)).

As above, also in the second embodiment, the shortening of the setup time and the securing of the tolerance against the same code succession can be simultaneously realized without applying the peak detection, and, at the same time, the stabilization of the packet detection can be realized, whereby there is an advantage that the stabilization of the operation of the optical receiving circuit 20 can be realized.

In the second embodiment, the rising edge detection unit and the set signal output unit are constituted by detecting, with the determination unit 27c, the rising edge of the burst optical signal based on the monitor electrical signals M1 and M2 from the amplifiers 27b-1 and 27b-2; however, according to the present invention, the falling edge of the burst optical signal may be detected based on the monitor electrical signals M1 and M2, and a falling edge determination unit and a reset signal output unit may be constituted by the detection of the falling edge of the burst optical signal. Namely, the falling edge detected as above can be applied as the rest input to the latch circuit 5, as with the case of the modification of the first embodiment.

For instance, when the determination unit 27c as the falling edge determination unit detects that the monitor electrical signal M2 larger than the monitor electrical signal M1 becomes equal to the monitor electrical signal M1 (see, t6 in (b) of FIG. 12). Namely, the determination unit 27c can detect this event as the falling edge of the burst optical signal. The delay unit 28 as a second delay unit (see, 18 of FIG. 9) gives a delay to the detection result showing the falling edge of the burst optical signal, and thereafter, the reset signal is output to the latch circuit 5 (see, t7 in (e) and (f) of FIG. 12).

Needless to say, as with the case in FIG. 7, the rising edge and the falling edge of the burst optical signal are detected in the implementation of the second embodiment, and the rising edge and the falling edge may respectively serve as the set input and the reset input to the latch circuit 5.

### [C] Description of a Third Embodiment

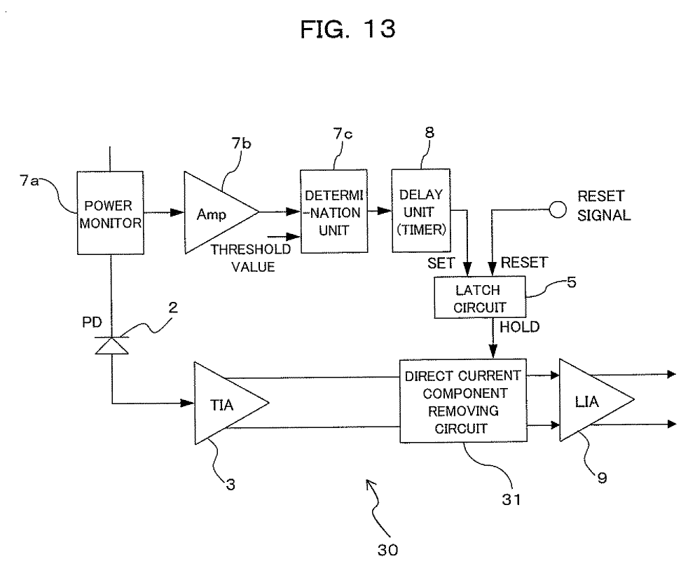

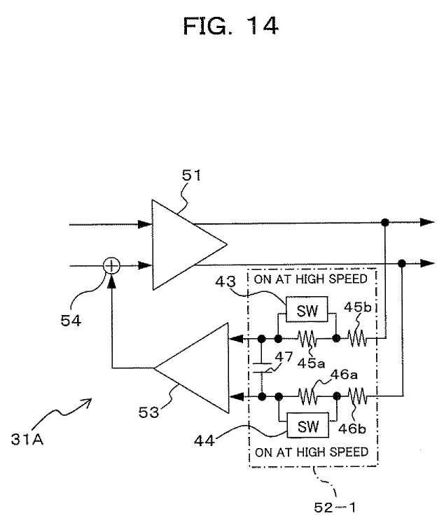

FIG. 13 is a view showing an optical receiving apparatus 30 according to the third embodiment of the present invention. The optical receiving apparatus 30 shown in FIG. 13 has a direct-current component removing circuit 31 different from those in the first and second embodiments. In FIG. 13, the same reference numerals as FIG. 1 denote similar units as in FIG. 1, and the detailed description is omitted. The direct-current component removing circuit 31 couples only AC (Alternating Current) components regarding an output signal from the TIA 3, and is constituted of a capacitor, direct-current component removing circuits 31A to 31D exemplified in FIGS. 14 to 17, or the like.

Further, the direct-current component removing circuit 31 is constituted so that the response time constant can be varied in response to the input of the hold signal from the latch circuit 5 and the release of the hold signal. Here, the direct-current component removing circuit 31A shown in FIG. 14 has an amplifier 51 which amplifies two optical receiving signal components (differential signal) from the TIA 3 and uses the two optical receiving signal components as a differential output, an RC circuit 52-1 which uses the two output signals from the amplifier 51 as an input, an amplifier 53 which outputs a level corresponding to the average value of the two optical receiving signal components from the RC circuit 52-1, and an adder 54 which adds the output signal from the amplifier 53, which is a signal of a direct-current component to be removed, to one of the differential signals from the TIA 3 to the amplifier 51.

The RC circuit 52-1 shown in FIG. 14 has a constitution similar to the RC circuit 42-1 shown in FIG. 2 and uses the two outputs from the amplifier 51 as an input. Namely, the switch circuits 43 and 44 are respectively connected to the both ends of the resistances 45a and 46a, and are turned on by the reset of the hold signal from the latch circuit 5, while they are turned off by the set of the hold signal. Thus, the respective both ends of the resistances 45a and 46a are switched on/off by the switch circuits 43 and 44, whereby the response time constant in the RC circuit 52-1 can be switched.

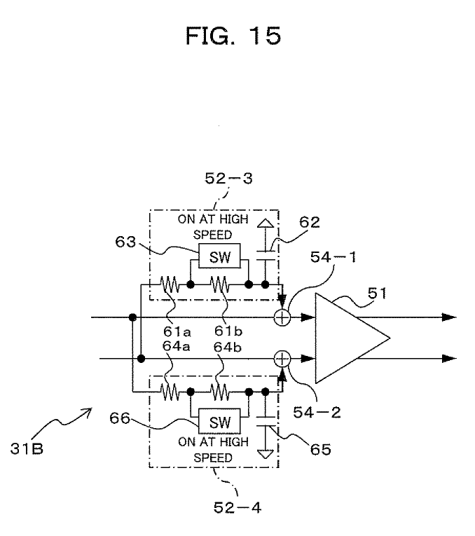

Further, the direct-current component removing circuit 31B shown in FIG. 15 has the amplifier 51 similar to that shown in FIG. 14, and, at the same time, has RC circuits 52-3 and 52-4 and adders 54-1 and 54-2. The RC circuit 52-3 extracts the direct-current component from an input 3-2 regarding the two inputs 3-1 and 3-2 from the TIA 3 to the amplifier 51 and adds the extracted direct-current component to the input 3-1 through the adder 54-1. Meanwhile, the RC circuit 52-4 extracts the direct-current component from the input 3-1 from the TIA 3 to the amplifier 51 and adds the extracted direct-current component to the input 3-2 through the adder 54-2. According to this constitution, the amplifier 51 can output a signal obtained by removing the direct-current component contained in a signal from the TIA 3.

Here, the RC circuit 52-3 is constituted to have resistances 61a and 61b, a capacitance 62, and a switch 63, and switches on/off of the connection of the resistance 61b with the switch 63. Namely, the switch 63 connected to the both ends of the resistance 61b is turned on by the reset of the hold signal from the latch circuit 5 and is turned off by the set of the hold signal from the latch circuit 5, whereby the response time constant of the RC circuit 52-3 can be switched.

Likewise, the RC circuit 52-4 is constituted to have resistances 64a and 64b, a capacitance 65, and a switch 66, and switches on/off of the resistance 64b with the switch 66. Namely, the switch 66 connected to the both ends of the resistance 64b is turned on by the reset of the hold signal from the latch circuit 5 and is turned off by the set of the hold signal from the latch circuit 5, whereby the response time constant of the RC circuit 52-4 can be switched.

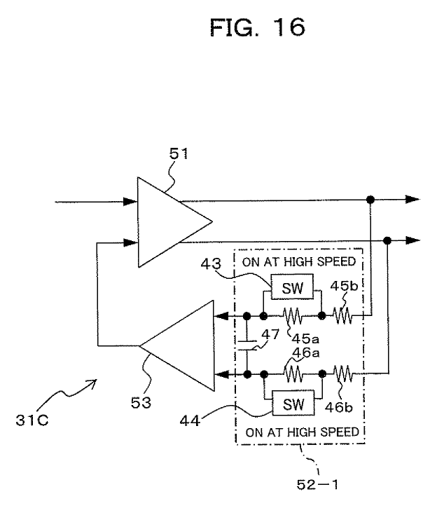

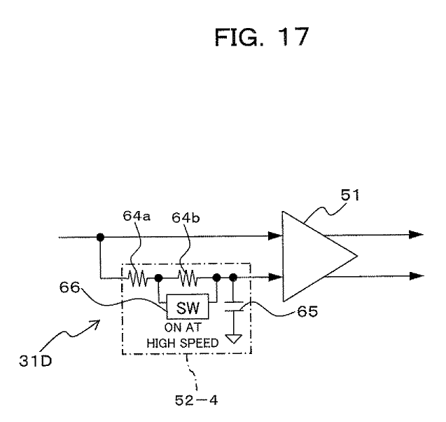

The TIA 3 is not limited to be a differential output, but the TIA 3 may serve as one output. In this case, the TIA 3 can be used as a direct-current component removing circuit 31C or 31D exemplified in FIG. 16 or 17. The direct-current component removing circuit 31C shown in FIG. 16 has the amplifier 51, the RC circuit 52-1, and the amplifier 53 similar to those shown in FIG. 14. An output from the TIA 3 serves as one input to the amplifier 51, and a signal which is supplied from the amplifier 53 and free from a direct-current component serves as another input to the amplifier 51. The direct-current component removing circuit 31C outputs a signal from which the direct-current component is removed in the amplifier 51.

Meanwhile, the direct-current component removing circuit 31 D shown in FIG. 17 has the amplifier 51 and the RC circuit 52-4 similar to those shown in FIG. 15. An output from the TIA 3 serves as one input to the amplifier 51, and a signal which is supplied from the RC circuit 52-4 and free from a direct-current component serves as another input to the amplifier 51. The direct-current component removing circuit 31D outputs a signal from which the direct-current component is removed in the amplifier 51.

In the direct-current component removing circuits 31A to 31D having the above constitution, the response time constant is reduced by turning on the switch, whereby the response of the RC circuit is conducted at a relatively high speed, and, at the same time, the next burst optical signal can be detected at the falling edge of the burst optical signal. Meanwhile, the response time constant is increased by turning off of the switch, whereby the response of the RC circuit is conducted at a relatively low speed, and, at the same time, the tolerance against the same code succession can be improved.

According to the above constitution, in the stage before the rising edge of the burst optical signal, the hold signal is released in the latch circuit 5. In this case, the response time constant of the direct-current component removing circuit 31 shown in FIG. 13 is set to be a relatively small value. According to this constitution, the early rising of a received signal upon input of the optical packet can be realized.

Meanwhile, when the rising edge of the burst optical signal is detected in the rising edge detection unit 7, a set signal from the delay unit 8 as a set signal output unit is input to the latch circuit 5. The latch circuit 5 outputs the hold signal to the direct-current component removing circuit 31 based on the input of the set signal. According to this constitution, the response time constant of the direct-current component removing circuit 31 becomes a relatively large value, whereby it is possible to secure the output of a response signal with high accuracy with respect to the same code succession in the stage of inputting the optical packet.

Thus, also in the third embodiment, an advantage similar to the case of the first embodiment can be obtained by taking advantage of the latch circuit 5 and the direct-current component removing circuit 31.

In the third embodiment, the set signal output unit similar to that in the first embodiment (see, FIG. 1) is constituted; however, according to the present invention, the constitutions in the modification of the first embodiment and the second embodiment can be applied as the implementation of generating the set signal and the reset signal to the latch circuit 5.

### [C1] Description of a Modification of the Third Embodiment

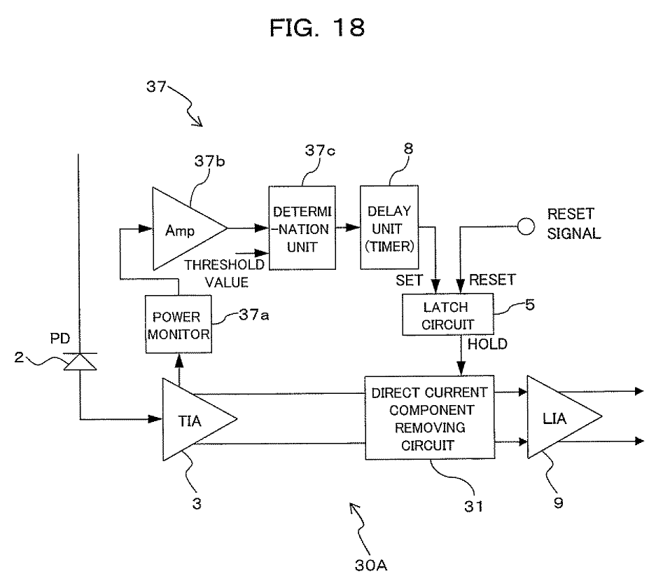

FIG. 18 is a view showing an optical receiving apparatus 30A according to a first modification of the third embodiment of the present invention. The optical receiving apparatus 30A shown in FIG. 18 is different from that shown in FIG. 13, and has a power monitor 37a which monitors an input power to the TIA 3 as a preamplification unit for the purpose of detecting the rising edge of the burst optical signal. An amplifier 37b amplifies the electrical signal, and, thus, to regulate the electrical signal level as the monitoring result from the power monitor 37a. A determination unit 37c detects the head of the burst optical signal constituted of the optical packet, that is, the rising edge of the burst optical signal based on the monitoring result input through the amplifier 37b, that is, the result of monitoring the level of the electrical signal, which is received in the PD 2 to be input to the TIA 3.

Specifically, the determination unit 37c compares the magnitude between the electrical signal as the monitoring result of the optical reception level input through the amplifier 37b and a predetermined threshold level and, when the electrical signal as the monitoring result is larger than the threshold level, detects the rising edge of the input of the optical packet constituting the burst optical signal. At this time, when the burst optical signal rises, the response informing the rising edge of the burst optical signal is output within the preamble time of the optical packet constituting the burst optical signal. Accordingly, the power monitor 37a, the amplifier 37b, and the determination unit 37c constitute a rising edge detection unit 37 which detects the rising edge of the burst optical signal. When the rising edge detection unit 37 and the delay unit 8 similar to that shown in FIG. 13 detect the rising edge of the burst optical signal, a set signal output unit which outputs a set signal serving as a set input to the latch circuit 5 is constituted.

Also in the optical receiving apparatus 30A having the above constitution, an operational effect similar to the case of the third embodiment can be obtained.

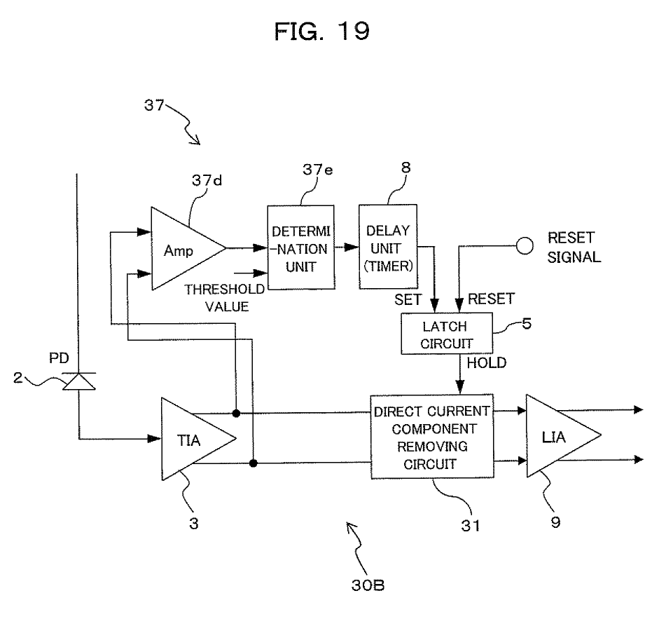

FIG. 19 is a view showing an optical receiving apparatus 30B according to a second modification of the third embodiment of the present invention. The optical receiving apparatus 30B shown in FIG. 19 is different from that shown in FIGS. 13 and 12, and generates a set signal to the latch circuit 5 with the use of an output signal output from the TIA 3. Therefore, the optical receiving apparatus 30B has an amplifier 37d and a determination unit 37e for the purpose of generating the set signal to the latch circuit 5.

The amplifier 37d amplifies the output signal from the TIA 3, and, thus, to regulate the level of the output signal. The determination unit 37e compares the magnitude between the electrical signal as the monitoring result input through the amplifier 37d and a predetermined threshold level and, when the electrical signal as the monitoring result is larger than the threshold level, detects the rising edge of the input of the optical packet constituting the burst optical signal.

Thus, the amplifier 37d and the determination unit 37e constitute the rising edge detection unit 37 for detecting the rising edge of the burst optical signal. When the rising edge detection unit 37 and the delay unit 8 similar to that shown in FIG. 13 detect the rising edge of the burst optical signal, a set signal output unit which outputs a set signal serving as a set input to the latch circuit 5 is constituted.

In the first and second modifications of the third embodiment, the set signal to the latch circuit 5 is generated by using the power of the optical receiving signal input to the TIA 3; however, according to the present invention, a reset signal may be generated by using the power of the optical receiving signal input to the TIA 3, or both the set signal and the reset signal may be generated.

### [D] Description of a Forth Embodiment

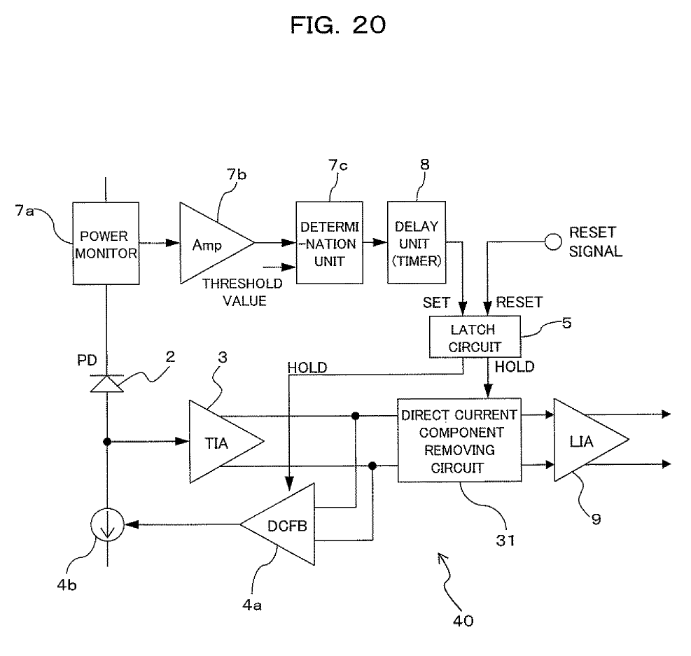

FIG. 20 is a view showing an optical receiving apparatus 40 according to the forth embodiment of the present invention. The optical receiving apparatus 40 shown in FIG. 20 has the same constitution as the optical receiving apparatus 1 in the first embodiment and further has the direct-current component removing circuit 31 in the third embodiment. In FIG. 20, the same reference numerals as FIGS. 1 and 13 denote similar units as in FIGS. 1 and 13. In the optical receiving apparatus 40 having the above constitution, by taking advantage of the latch circuit 5, the DCFB 4a, the current source 4b, and the direct-current component removing circuit 31, the shortening of the setup time and the securing of the tolerance against the same code succession can be simultaneously realized without using a peak detection circuit.

### [E] Other

Regardless the disclosures of the above embodiments, the present invention can be variously modified and practiced without deuniting from the scope of the present invention.

Those skilled in the art can manufacture the claimed apparatus of the invention by the disclosures of the above embodiments.

What is claimed is:

1. An optical receiving apparatus comprising:
an optical receiving unit which receives a burst optical signal and outputs a signal in accordance with an optical reception level;
a preamplification unit which amplifies a signal from the optical receiving unit;
a direct-current component removing unit which removes a direct-current component of a signal output from the preamplification unit and has a variable response time constant; and
a time-constant control unit which controls the response time-constant of the direct-current component removing unit based on a signal indicating a rising edge of the burst optical signal and a signal indicating a falling edge of the burst optical signal.

2. The optical receiving apparatus as claimed in claim 1, wherein the time-constant control unit is constituted as a hold signal output unit which generates and outputs a hold signal by using a signal indicating a rising edge of the burst optical signal as a set input, and using a signal indicating a falling edge of the burst optical signal as a reset input,
wherein the hold signal output unit controls the response time constant of the direct-current component removing unit to be relatively large when the hold signal is set and to be relatively small when the hold signal is reset.

3. The optical receiving apparatus as claimed in claim 1, wherein the direct-current component removing unit includes a negative feedback circuit which negatively feeds back a direct-current component of a signal output from the preamplification unit to a signal output from the optical receiving unit to the preamplification unit.

4. The optical receiving apparatus as claimed in claim 1, wherein the direct-current component removing unit outputs a signal obtained by removing a direct-current component from a signal output from the preamplification unit.

5. The optical receiving apparatus as claimed in claim 2, wherein the hold signal output unit includes a latch circuit.

6. The optical receiving apparatus as claimed in claim 2, further comprising a set signal output unit which, when detecting a rising edge of the burst optical signal, outputs a set signal serving as the set input to the hold signal output unit,
wherein the hold signal output unit outputs the hold signal based on the set signal as the set input from the set signal output unit and the reset input from the outside.

7. The optical receiving apparatus as claimed in claim 2, further comprising:
a set signal output unit which, when detecting a rising edge of the burst optical signal, outputs a set signal serving as the set input to the hold signal output unit; and
a reset signal output unit which, when detecting a falling edge of the burst optical signal, outputs a reset signal serving as the reset input to the hold signal output unit,
wherein the hold signal output unit outputs the hold signal based on the set signal as the set input from the set signal output unit and the reset signal as the reset input from the reset signal output unit.

8. The optical receiving apparatus as claimed in claim 2, further comprising a rest signal output unit which, when detecting a falling edge of the burst optical signal, outputs a rest signal serving as the reset input to the hold signal output unit,
wherein the hold signal output unit outputs the hold signal based on the set input from the outside and the reset signal as the reset input from the reset signal output unit.

9. The optical receiving apparatus as claimed in claim 6, wherein the set signal output unit comprises a rising edge detection unit which detects the rising edge of the burst optical signal and a first delay unit which gives a delay to a signal indicating a detection result in the rising edge detection unit and outputs the signal as the set signal to the hold signal output unit.

10. The optical receiving apparatus as claimed in claim 7, wherein the set signal output unit comprises a rising edge detection unit which detects the rising edge of the burst optical signal and a first delay unit which gives a delay to a signal indicating a detection result in the rising edge detection unit and outputs the signal as the set signal to the hold signal output unit.

11. The optical receiving apparatus as claimed in claim 7, wherein the reset signal output unit comprises a falling edge detection unit which detects the falling edge of the burst optical signal and a second delay unit which gives a delay to a signal indicating a detection result in the falling edge detection unit and outputs the signal as the reset signal to the hold signal output unit.

12. The optical receiving apparatus as claimed in claim 8, wherein the reset signal output unit comprises a falling edge detection unit which detects the falling edge of the burst optical signal and a second delay unit which gives a delay to a signal indicating a detection result in the falling edge detection unit and outputs the signal as the reset signal to the hold signal output unit.

13. The optical receiving apparatus as claimed in claim 2, wherein the hold signal output unit outputs the hold signal based on the set input and the reset input from the outside.

14. The optical receiving apparatus as claimed in claim 1, wherein the optical receiving unit includes a photodiode, and outputs an electrical signal of the photodiode to the preamplification unit.

15. The optical receiving apparatus as claimed in claim 9, wherein the rising edge detection unit comprises: a first monitor which monitors a power of a signal received by the optical receiving unit and has a relatively small time constant; a second monitor which monitors a power of a signal received by the optical receiving unit and has a relatively large time constant; and a rising edge determination unit which detects a rising edge of the burst optical signal based on a monitoring result in the first and second monitors and outputs a detection result as the set input to the hold signal output unit.

16. The optical receiving apparatus as claimed in claim 10, wherein the rising edge detection unit comprises: a first monitor which monitors a power of a signal received by the optical receiving unit and has a relatively small time constant; a second monitor which monitors a power of a signal received by the optical receiving unit and has a relatively large time-constant; and a rising edge determination unit which detects the rising edge of the burst optical signal based on a monitoring result in the first and second monitors and outputs a detection result as the set input to the hold signal output unit.

17. An optical line terminal apparatus in an optical network system comprising the optical receiving apparatus as claimed in claim 1.

18. An optical network system comprising an optical line terminal apparatus to which the optical receiving apparatus as claimed in claim 1 is applied.
